(19) United States
(12) Patent Application Publication
(10) Pub. No.: US 2026/0241562 A1
(43) Pub. Date: Aug. 20, 2026

(54) DEVICE, METHOD, AND COMPUTER PROGRAM FOR RESTRICTING MOVEMENT OF ROBOT

(71) Applicant: FANUC CORPORATION, Yamanashi (JP)

(72) Inventors: Kunihiko Harada, Yamanashi (JP); Yasuhiro Naitou, Yamanashi (JP); Tomoyuki Yamamoto, Yamanashi (JP)

(21) Appl. No.: 19/159,809

(22) PCT Filed: Mar. 27, 2023
(86) PCT No.: PCT/JP2023/012278

§ 371 Date: Aug. 26, 2025

(51) Int. Cl. B25J 9/16

(52) U.S. Cl. CPC B25J 9/1666

(57) ABSTRACT

A device including a position acquisition unit that acquires the current position of a robot; a direction setting unit that determines a first direction toward the outside and a second direction orthogonal to the first direction on the basis of the current position acquired by the position acquisition unit and a boundary of an allowable operation range close to the current position; a command generation unit that, in order to move the robot, generates a first movement command for moving the robot in the first direction determined by the direction setting unit and a second movement command for moving the robot in the second direction determined by the direction setting unit; and a movement restriction unit for restricting the movement of the robot according to the first movement command while permitting the movement of the robot according to the second movement command.

### CROSS-REFERENCE TO RELATED APPLICATIONS

This application is a National Stage application of International Application No. PCT/JP 2023/012278 filed Mar. 27, 2023.

### BACKGROUND

### Field

The present disclosure relates to an apparatus, method, and computer program for restricting the movement of a robot toward outside of an allowable operation range.

### Discussion of the Related Art

A method of restricting the movement of a robot toward outside of an allowable operation range is known.

For example, there is a request to move the robot along the boundary of the allowable operation range while avoiding the robot from moving to the outside of the allowable operation range when causing the robot to perform a predetermined task or teaching the robot to perform the task.

### SUMMARY

In one aspect of the present disclosure, an apparatus that restricts a movement of a robot toward an outside of a predetermined allowable operation range, the apparatus including a position acquisition unit configured to acquire a current position of the robot; a direction setting unit configured to determine a first direction toward the outside and a second direction orthogonal to the first direction, on the basis of the current position acquired by the position acquisition unit and a boundary of the allowable operation range adjacent to the current position; a command generating unit configured to generate a first movement command for moving the robot in the first direction determined by the direction setting unit, a second movement command for moving the robot in the second direction determined by the direction setting unit, in order to move the robot, and a movement restriction unit configured to restrict a movement of the robot in accordance with the first movement command, while permitting a movement of the robot in accordance with the second movement command.

A method that restricts a movement of a robot toward an outside of a predetermined allowable operation range, is executed by a processor and includes acquiring a current position of the robot; determining a first direction toward the outside and a second direction orthogonal to the first direction, on the basis of the acquired current position and a boundary of the allowable operation range adjacent to the current position; generating a first movement command for moving the robot in the determined first direction; and a second movement command for moving the robot in the determined second direction, in order to move the robot; restricting a movement of the robot in accordance with the first movement command, while permitting a movement of the robot in accordance with the second movement command.

### BRIEF DESCRIPTION OF THE DRAWINGS

FIG. 1 is a schematic diagram of a robot system according to an embodiment.

FIG. 2 is a block diagram of the robot system illustrated in FIG. 1.

FIG. 3 is an example of an allowable operation range.

FIG. 4 is a flowchart illustrating an example of an operation flow of the robot system illustrated in FIG. 2.

FIG. 5 is a state in which the robot is placed in an adjacent region.

FIG. 6 is a flowchart illustrating an example of the flow of step S5 illustrated in FIG. 4.

FIG. 7 illustrates a reference point set at step S11 in FIG. 6.

FIG. 8 illustrates an operation range coordinate system set at step S12 in FIG. 6, and a first direction and a second direction.

FIG. 9 illustrates a target position acquired at step S13 in FIG. 6.

FIG. 10 illustrates an example of an image generated as a notification signal at step S14 in FIG. 6.

FIG. 11 illustrates a first movement command and a second movement command generated at step S16 in FIG. 6.

FIG. 12 is a block diagram schematically illustrating a signal transmission path in a movement restriction processing executed at steps S18 and S19 in FIG. 6.

FIG. 13 is a block diagram illustrating other functions of the robot system illustrated in FIG. 1.

FIG. 14 is a flowchart illustrating an example of step S5 executed by the robot system illustrated in FIG. 13.

FIG. 15 illustrates a first force component and a second force component calculated at step S21 in FIG. 14.

FIG. 16 is a block diagram schematically illustrating a signal transmission path in the movement restriction processing executed at steps S22 to S25 in FIG. 14.

FIG. 17 is a block diagram illustrating yet other functions of the robot system illustrated in FIG. 1.

FIG. 18 illustrates a position and a movement path of the robot during restricted movement.

FIG. 19 illustrates a newly set allowable operation range.

FIG. 20 illustrates another example of an allowable operation range.

FIG. 21 illustrates a first direction and a second direction set on the basis of the boundary of the allowable operation range illustrated in FIG. 20.

### DESCRIPTION OF THE EMBODIMENTS

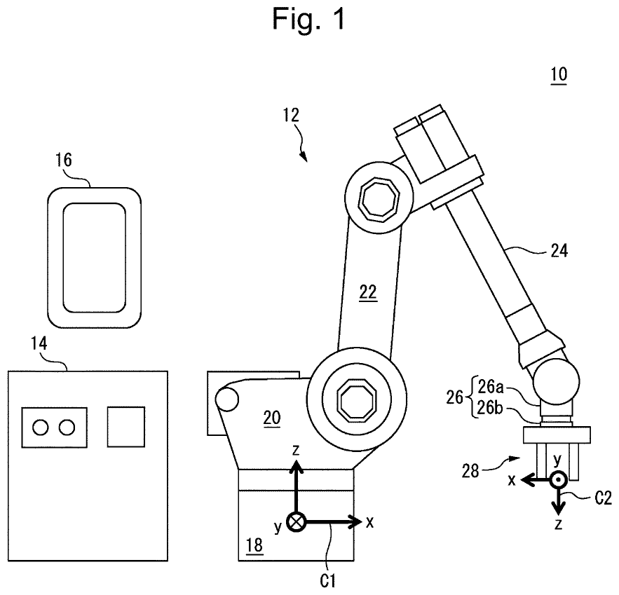

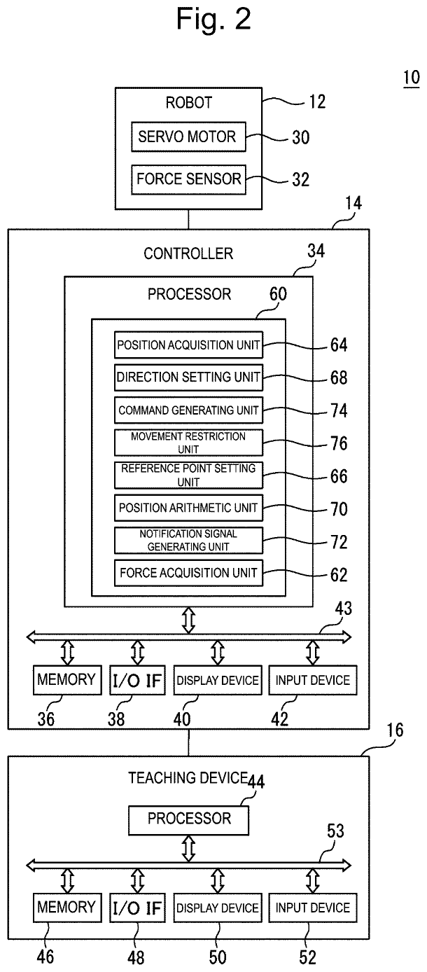

Embodiments of the present disclosure are described in detail below with reference to the drawings. In the various embodiments described below, similar elements are denoted by the same reference signs, and duplicate descriptions will be omitted. First, a robot system 10 according to one embodiment will be described with reference to FIGS. 1 and 2. The robot system 10 includes a robot 12, a controller 14, and a teaching device 16.

In the present embodiment, the robot 12 is a vertical articulated robot, which includes a robot base 18, a swivel body 20, a lower arm 22, an upper arm 24, a wrist 26, and an end effector 28. The robot base 18 is fixed on the floor of a work cell or on an unmanned automated guided vehicle (AGV). The swivel body 20 is provided on the robot base 18 so as to be pivotable about a vertical axis. The lower arm 22 is provided on the swivel body 20 and has a base end pivotable about a horizontal axis.

The upper arm 24 has a base end rotatably provided at the distal end of the lower arm 22. The wrist 26 includes a wrist base 26a provided at a distal end of the upper arm 24 so as to be rotatable around two axes orthogonal to each other, and a wrist flange 26b rotatably provided at the wrist base 26a. The end effector 28 is detachably attached to the wrist flange 26b. The end effector 28 is, for example, a robot hand, a welding torch, a cutting tool, or a laser processing head, and executes a predetermined operation (workpiece handling, welding, cutting, or laser processing) on a workpiece (not illustrated).

Each component (robot base 18, swivel body 20, lower arm 22, upper arm 24, wrist 26) of the robot 12 is provided with a servo motor 30 (FIG. 2). These servo motors 30 rotate and drive the respective drive shafts of the robot 12 in accordance with commands from the controller 14, thereby rotating the respective movable components of the robot 12 such as the swivel body 20, the lower arm 22, the upper arm 24, the wrist base 26a, and the wrist flange 26b (i.e., the end effector 28) around the respective drive shafts. Thus, the robot 12 can move a workpiece W held by the end effector 28 to an arbitrary position.

The robot 12 is provided with a force sensor 32 (FIG. 2) that detects a force F applied to the robot 12. The force sensor 32 has, for example, a 6-axis force sensor provided in any component (e.g., robot base 18 or wrist 26) of the robot 12, or a torque sensor provided in each of the drive shafts of the robot 12 driven by the servo motor 30, and supplies detection data Df of the detected force F to the controller 14.

As illustrated in FIG. 1, the robot 12 has a robot coordinate system C1 and a tool coordinate system C2. The robot coordinate system C1 is a fixed coordinate system for controlling the operation of each movable component of the robot 12. In the present embodiment, the robot coordinate system C1 is set relative to the robot base 18 such that the origin is located at the center of the robot base 18 and the z-axis is parallel to (specifically, coincides with) the pivot axis of the swivel body 20.

On the other hand, the tool coordinate system C2 is a moving coordinate system that defines the position of the end effector 28 in the robot coordinate system C1. In the present embodiment, the tool coordinate system C2 is set relative to the end effector 28 such that the origin (so-called TCP) is located at the work position (workpiece gripping position, welding position, cutting position, or laser exit port) of the end effector 28. Note that the tool coordinate system C2 may be located at any position.

When the end effector 28 is moved in the robot coordinate system C1, the controller 14 sets the tool coordinate system C2 in the robot coordinate system C1, and generates a command to each servo motor 30 to dispose the end effector 28 at the position represented by the set tool coordinate system C2. Thus, the controller 14 can position the end effector 28 at any position in the robot coordinate system C1 by driving each servo motor 30. In this paper, the term “position” may refer to a position and an orientation.

The controller 14 is a computer including a processor 34, a memory 36, an I/O interface 38, a display device 40, and an input device 42. The processor 34 includes a CPU, a GPU, or the like, and is communicably connected to the memory 36, the I/O interface 38, the display device 40, and the input device 42 via a bus 43, and performs arithmetic processing to achieve various functions described below while communicating with these components.

The memory 36 includes a RAM, a ROM, or the like, and temporarily or permanently stores various data. The memory 36 may be a computer-readable non-transitory recording medium, such as a semiconductor memory, a magnetic recording medium, or an optical recording medium. The I/O interface 38 includes, for example, an Ethernet (Registered Trademark) port, a USB port, an optical fiber connector, or an HDMI (Registered Trademark) terminal, and wiredly or wirelessly communicates data with external devices under commands from the processor 34.

The display device 40 includes a liquid crystal display or an organic EL display, or the like, and visually displays various data under commands from the processor 34. The input device 42 includes a push button, a switch, a keyboard, a mouse, or a touch panel, or the like, and receives input of data from an operator. The display device 40 and the input device 42 may be integrated into a housing of the controller 14, or may be connected to the I/O interface 38 as a single computer (such as a PC) separate from the housing of the controller 14.

The teaching device 16 teaches the operation of the robot 12. Specifically, the teaching device 16 is a computer including a processor 44, a memory 46, an I/O interface 48, a display device 50, and an input device 52. The teaching device 16 may be any type of computer, such as a teaching pendant or a notebook or a tablet PC.

The processor 44 is communicably connected to the memory 46, the I/O interface 48, the display device 50, and the input device 52 via a bus 53. The configuration of the processor 44, the memory 46, the I/O interface 48, the display device 50, and the input device 52 is the same as that of the processor 34, the memory 36, the I/O interface 38, the display device 40, and the input device 42 described above, so that duplicate descriptions are omitted.

In the present embodiment, the processor 34 of the controller 14 is configured to execute a jog mode MD1 and a direct teaching mode MD2 as an operation mode MD of the robot 12. In the jog mode MD1, the processor 34 moves the movable components of the robot 12 in the direction in which the operator inputs the input device 52 to move according to a jog command Cj that the operator inputs by operating the input device 52 of the teaching device 16.

On the other hand, in the direct teaching mode MD2, in accordance with a handling force Fh applied to an arbitrary movable component (e.g., the wrists 26 or the end effector 28) of the robot 12 by the operator, the processor 34 moves the movable component to which the handling force Fh is applied in the direction of the handling force Fh. The operator can operate the input device 42 of the teaching device 16 and select the jog mode MD1 or the direct teaching mode MD2 as the operation mode MD.

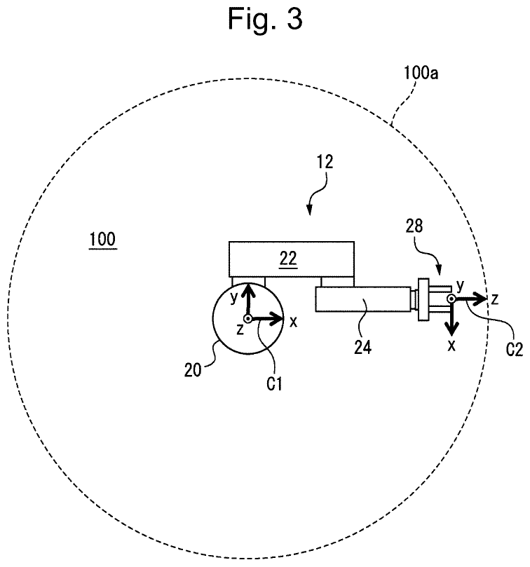

Here, an allowable operation range 100 is predetermined for the robot 12 in order to ensure the safety of the operation of the robot 12 when the robot 12 is performing work or taught for the work. An example of the allowable operation range 100 is illustrated in FIG. 3. In the example illustrated in FIG. 3, the allowable operation range 100 is defined as a substantially circular (e.g., cylindrical) range within a predetermined distance from the robot base 18 (i.e., the origin of the robot coordinate system C1). The outer edge of the allowable operation range 100 is defined by a cylindrical boundary 100a, and the processor 34 restricts the movement of the robot 12 toward the outside of the allowable operation range 100.

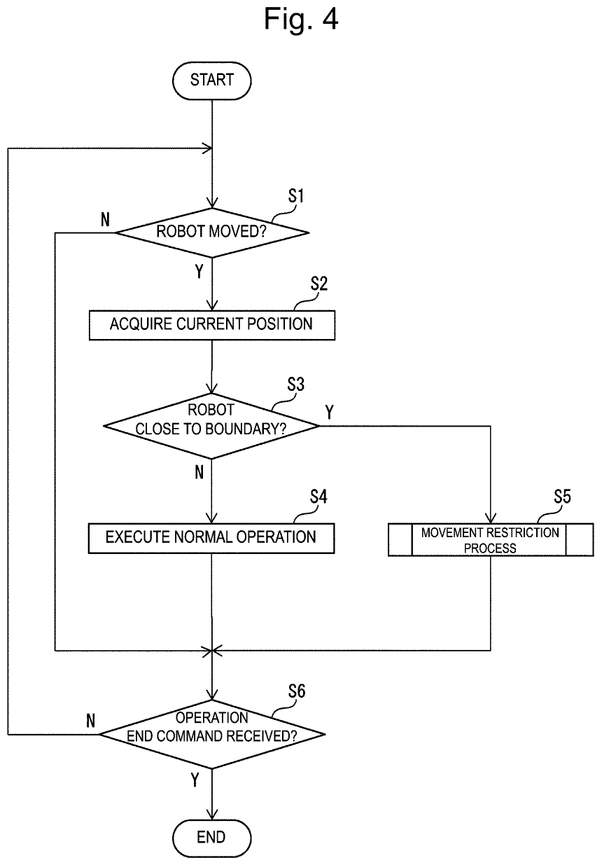

A method of restricting the movement of the robot 12 will be described below with reference to FIG. 4. The processor 34 starts the flow of FIG. 4 when receiving an operation start command from the operator, a host controller, or a computer program PG. At the start of the flow of FIG. 4, the robot 12 (i.e., the end effector 28) is within the allowable operation range 100.

In step S1, the processor 34 determines whether or not to have received the command to move the robot 12. As an example, while the jog mode MD1 is executed, the processor 34 determines YES when receiving the jog command Cj from the teaching device 16. As another example, when the direct teaching mode MD2 is executed, the processor 34 continuously (e.g., periodically) calculates, on the basis of the detection data Df of the force sensor 32, the magnitude and direction of the handling force Fh added by the operator to the movable component of the robot 12 in order to move the robot 12.

In this way, the processor 34 functions as a force acquisition unit 62 (FIG. 2) that acquires the handling force Fh on the basis of the detection data Df. Then, the processor 34 determines YES when the acquired handling force Fh exceeds a predetermined threshold value Fth (Fh≥Fth). The processor 34 proceeds to step S2 when determining YES, and proceeds to step S6 when determining NO. Hereinafter, a case will be described in which the operator gives a command (jog command Cj or handling force Fh) to move the end effector 28 of the robot 12 outside the allowable operation range 100 to the processor 34.

In step S2, the processor 34 acquires a current position Pc of the robot 12. Specifically, on the basis of detection data Dr of the rotation detection sensor (encoder, Hall element, or the like) that detects the rotational position (or rotation angle) of each servo motor 30 at this time, the processor 34 acquires the coordinates Qc (x_{c}, y_{c}, z_{c}) in the robot coordinate system C1 at the origin of the tool coordinate system C2 at this time as position data of the current position Pc. Thus, the processor 34 functions as a position acquisition unit 64 (FIG. 2) that acquires the current position Pc of the robot 12.

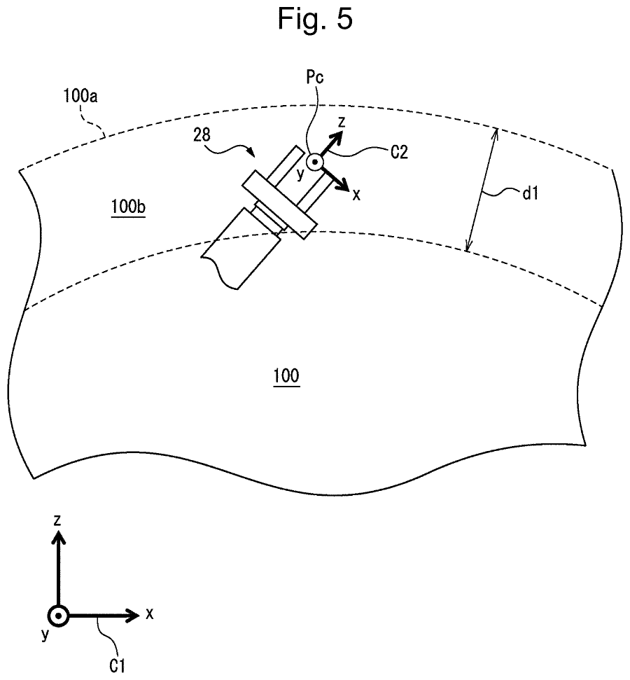

In step S3, the processor 34 determines whether or not the robot 12 is within an adjacent region 100b close to the boundary 100a of the allowable operation range 100. This adjacent region 100b is predetermined by the operator based on the boundary 100a of the allowable operation range 100. An example of the adjacent region 100b is illustrated in FIG. 5. In the example illustrated in FIG. 5, the adjacent region 100b is defined as a range in which the distance d from the boundary 100a toward the inside of the allowable operation range 100 (e.g., toward the origin of the robot coordinate system C1) is 0≤d≤d1.

The processor 34 determines NO when the current position Pc acquired in the most recent step S2 is outside the adjacent region 100b (i.e., inside the allowable operation range 100 beyond the adjacent region 100b), and proceeds to step S4, while determining YES when the current position Pc is within the adjacent region 100b, and proceeds to step S5. FIG. 5 illustrates an example of the position of the robot 12 (end effector 28) when YES is determined in step S3.

In step S4, the processor 34 causes the robot 12 to execute a normal operation. For example, when the jog mode MD1 is executed, the processor 34 moves the end effector 28 of the robot 12 according to the jog command Cj received in the most recent step S1. Alternatively, when the direct teaching mode MD2 is executed, the processor 34 moves the end effector 28 to which the handling force Fh is added in the direction of the handling force Fh according to the handling force Fh acquired in the most recent step S1.

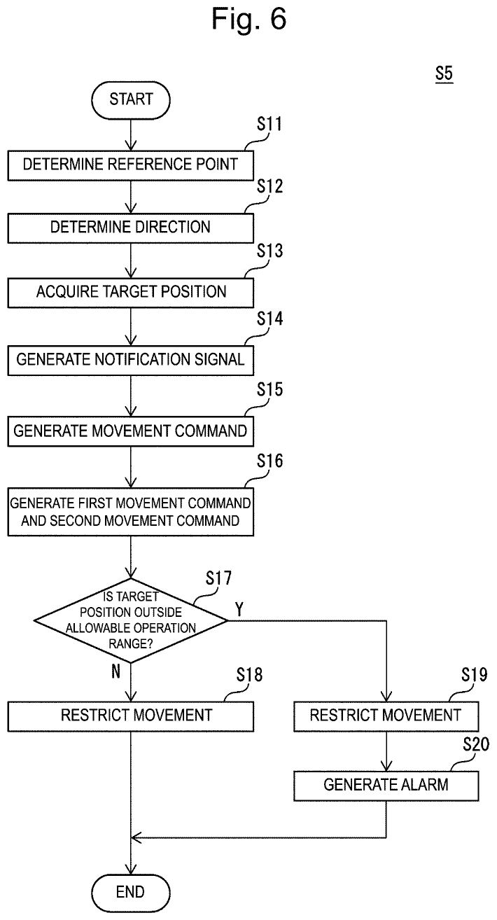

On the other hand, when YES is determined in step S3, the processor 34 executes the movement restriction process in step S5. This step S5 will be described with reference to FIG. 6. In step S11, the processor 34 determines a point on the boundary 100a, which is close to the current position Pc acquired most recently in step S2, as a reference point Pr.

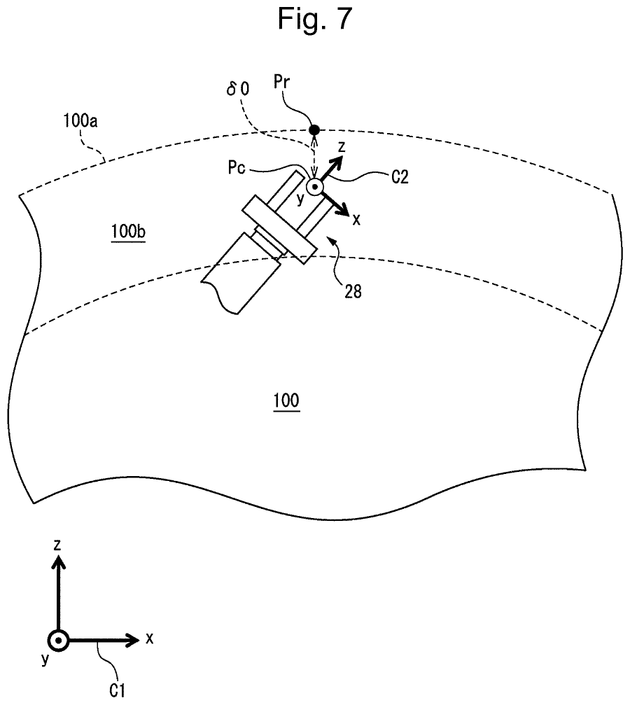

Specifically, the processor 34 determines a point Pr on the boundary 100a which has the minimum distance δ from the current position Pc acquired most recently. FIG. 7 illustrates a point Pr whose distance δ is a minimum value δ0. The processor 34 determines this point Pr as the reference point Pr and acquires coordinates Qr (xᵣ, yᵣ, zᵣ) in the robot coordinate system C1 of the reference point Pr. Thus, the processor 34 functions as a reference point setting unit 66 (FIG. 2) for determining the reference point Pr.

In step S12, the processor 34 determines a first direction DR1 toward the outside of the allowable operation range 100 and a second direction DR2 orthogonal to the first direction DR1 on the basis of the current position Pc acquired in the most recent step S2 and the boundary 100a of the allowable operation range 100 adjacent to the current position Pc. In the present embodiment, the processor 34 determines the first direction DR1 and the second direction DR2 based on the reference point Pr determined on the boundary 100a adjacent to the current position Pc in the immediately preceding step S11.

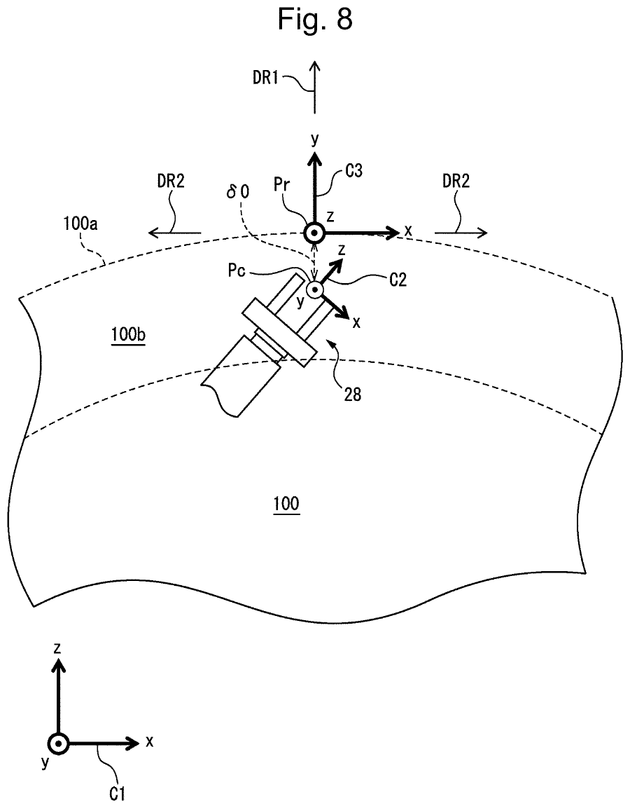

More specifically, as illustrated in FIG. 8, in the robot coordinate system C1, the processor 34 sets an operation range coordinate system C3 that determines the first direction DR1 and the second direction DR2. The origin of the operation range coordinate system C3 is disposed at the reference point Pr defined in the immediately preceding step S11. The y-axis of the operation range coordinate system C3 is parallel to the normal direction of the boundary 100a at the reference point Pr, and the positive direction of the y-axis is directed to the outside (i.e., away from the origin of the robot coordinate system C1) of the allowable operation range 100. The z-axis of the operation range coordinate system C3 may be parallel to the z-axis of the robot coordinate system C1.

Thus, the processor 34 sets the operation range coordinate system C3 with the reference point Pr as the origin. The y-axis direction of the operation range coordinate system C3 determines the first direction DR1, and the x-axis direction and the z-axis direction (i.e., the x-z plane) of the operation range coordinate system C3 determine the second direction DR2. That is, in the present embodiment, the first direction DR1 is parallel to the normal direction of the boundary 100a at the reference point Pr. The processor 34 acquires coordinates Qo (xᵣ, yᵣ, zᵣ, wₒ, pₒ, rₒ) in the robot coordinate system C1 of the set operation range coordinate system C3.

Among the coordinates Qo, (xᵣ, yᵣ, zᵣ) indicates coordinates of the origin (i.e., reference point Pr) of the operation range coordinate system C3 in the robot coordinate system C1, and (wₒ, pₒ, rₒ) indicates the orientation (i.e., the direction of each axis) of the operation range coordinate system C3 with respect to the robot coordinate system C1. Thus, the processor 34 determines the first direction DR1 and the second direction DR2 by setting the operation range coordinate system C3 with reference to the reference point Pr determined on the basis of the current position Pc and the boundary 100a. Thus, the processor 34 functions as a direction setting unit 68 (FIG. 2) that determines the first direction DR1 and the second direction DR2 on the basis of the current position Pc and the boundary 100a.

In step S13, the processor 34 acquires a target position Pt to move the robot 12 from the current position Pc acquired in the most recent step S2. As an example, when the jog mode MD1 is executed, the processor 34 calculates the target position Pt on the basis of the jog command Cj received in the most recent step S1 and the current position Pc obtained in the most recent step S2. The jog command Cj contains information that determines a movement direction DRm and the movement amount Δ to move the end effector 28.

As another example, when the direct teaching mode MD2 is executed, the processor 34 calculates the target position Pt on the basis of the handling force Fh acquired in the most recent step S1 and the current position Pc acquired in the most recent step S2. For example, a relation R_{Fh_Δ} between the magnitude of the handling force Fh and the movement amount Δ to move the robot 12 (i.e., end effector 28) according to the handling force Fh may be predetermined and stored in the memory 36 (or 46) in advance. For example, this relation R_{Fh_Δ} may be predetermined as a formula Δ=f(Fh)=α×Fh (alpha is a predetermined coefficient). Each term of function f(Fh) of the handling force Fh may be determined arbitrarily by the operator.

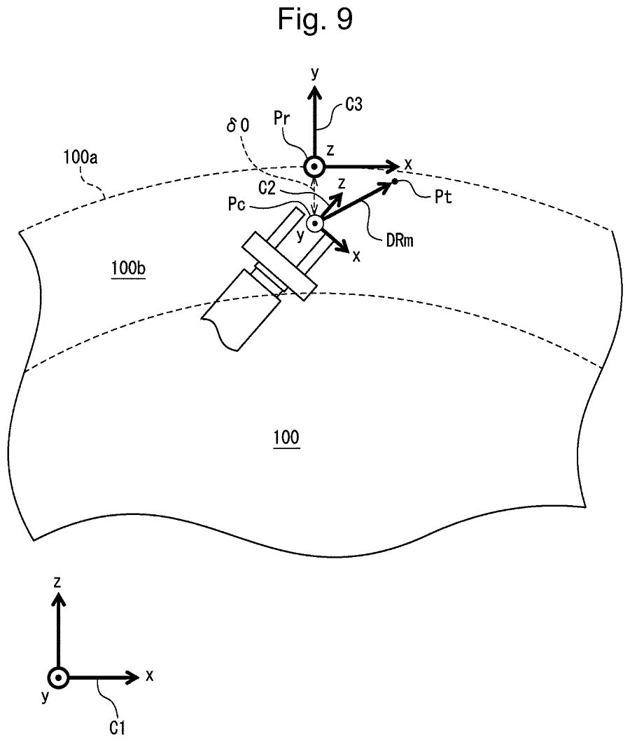

The processor 34 applies the handling force Fh acquired at the most recent step S1 to the relation R_{Fh_Δ} (i.e., the formula) and obtains the corresponding movement amount Δ. Then, the processor 34 calculates the target position Pt on the basis of the obtained movement amount Δ, the direction of the handling force Fh obtained at the most recent step S1, and the current position Pc. An example of the target position Pt thus obtained is illustrated in FIG. 9.

In the present embodiment, since the operator moves the robot 12 (end effector 28) to the outside of the allowable operation range 100, the target position Pt to be calculated is located outside the allowable operation range 100 (i.e., near the boundary B) than the current position Pc. Thus, the processor 34 functions as a position arithmetic unit 70 (FIG. 2) for obtaining the target position Pt.

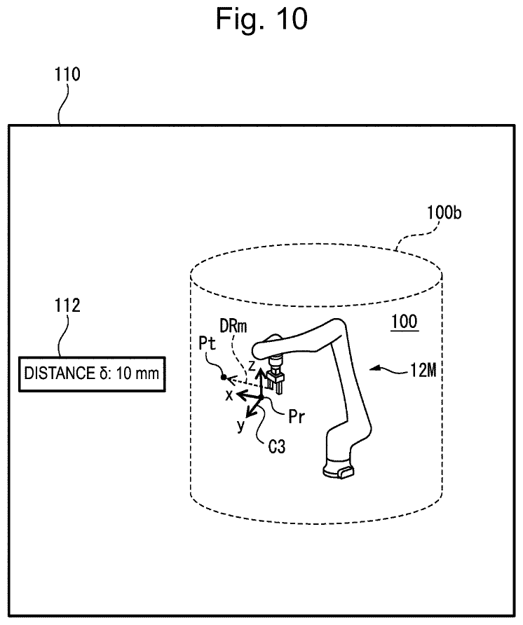

In step S14, the processor 34 generates a notification signal Sn. This notification signal Sn informs the operator of the movement direction DRm (FIG. 9) from the current position Pc to the target position Pt and the distance δ between the target position Pt and the boundary 100a. For example, the processor 34 generates an image 110 illustrated in FIG. 10 as the notification signal Sn. This image 110 is a graphical user interface (GUI) for visually informing the operator of the movement direction DRm and the distance δ.

Specifically, the image 110 illustrates a three-dimensional display of a robot model 12M (e.g., a 3D-CAD model) modeling the robot 12 and the allowable operation range 100 (boundary 100a). Additionally, the image 110 superimposes the operation range coordinate system C3 (i.e., first direction DR1 and second direction DR2) set in the most recent step S12 on the robot model 12M arranged in the current position Pc with the reference point Pr.

Then, the image 110 superimposes the target position Pt and the movement direction DRm obtained in the immediately preceding step S13 on the robot model 12M and displays the distance δ between the target position Pt and the boundary 100a at a distance display field 112. The processor 34 displays the generated image 110 on the display device 40 (or 50). In this way, the processor 34 functions as a notification signal generating unit 72 (FIG. 2) that generates the notification signal Sn (image 110).

The processor 34 may further display the distance δ between the current position Pc and the boundary 100a at the distance display field 112. The processor 34 may further display in the image 110 at least one of, the robot coordinate system C1 and the tool coordinate system C2, the coordinates Qc of the current position Pc, the coordinates Qr of the reference point Pr, and the coordinates Qo of the operation range coordinate system C3. The processor 34 may also display only one of the movement direction DRm and the distance δ at the image 110. In addition, the processor 34 may generate, as the notification signal Sn, an audio signal that describes the movement direction DRm or distance δ in voice instead of the image 110.

In step S15, the processor 34 generates a movement command Cm that moves the robot 12 (end effector 28) from the current position Pc to the target position Pt toward the outside of the allowable operation range 100. The movement command Cm includes, for example, a position command Cmₚ, a velocity command Cmᵥ, a torque command Cm_{q}, or an acceleration command Cmₐ, and drives each servo motor 30 of the robot 12 to move the end effector 28 to the target position Pt. Thus, the processor 34 functions as a command generating unit 74 (FIG. 2) that generates the movement command Cm.

In step S16, the processor 34 functions as the command generating unit 74, and generates a first movement command Cm₁ and a second movement command Cm₂ based on the operation range coordinate system C3 set in the most recent step S12. The first movement command Cm₁ is a command to move the robot 12 (specifically, end effector 28) in the first direction DR1 (the y-axis plus direction of the operation range coordinate system C3) set in the most recent step S12. On the other hand, the second movement command Cm₂ is a command to move the end effector 28 in the second direction DR2 (i.e., along the x-z plane of the operation range coordinate system C3) set in the most recent step S12.

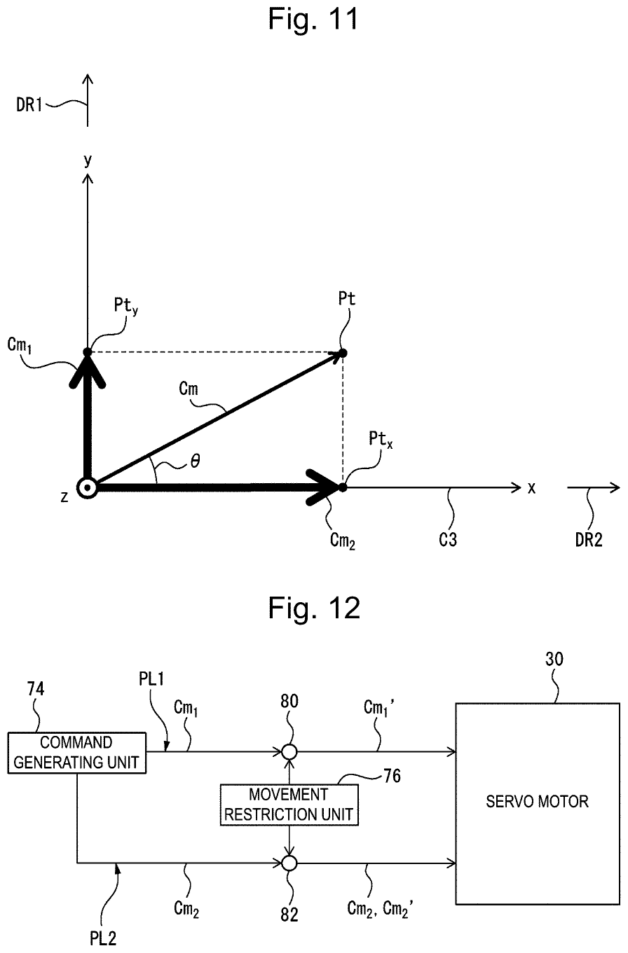

In the present embodiment, the processor 34 calculates the component Cm₁ in the y-axis plus direction (i.e., first direction DR1) of the operation range coordinate system C3 of the movement command Cm, on the basis of the coordinates Qo of the operation range coordinate system C3 in the robot coordinate system C1 and the movement command Cm generated in the most recent step S15. This calculation will be described with reference to FIG. 11. In FIG. 11, the vector Cm represents the movement vector of the end effector 28 by the movement command Cm generated in step S15.

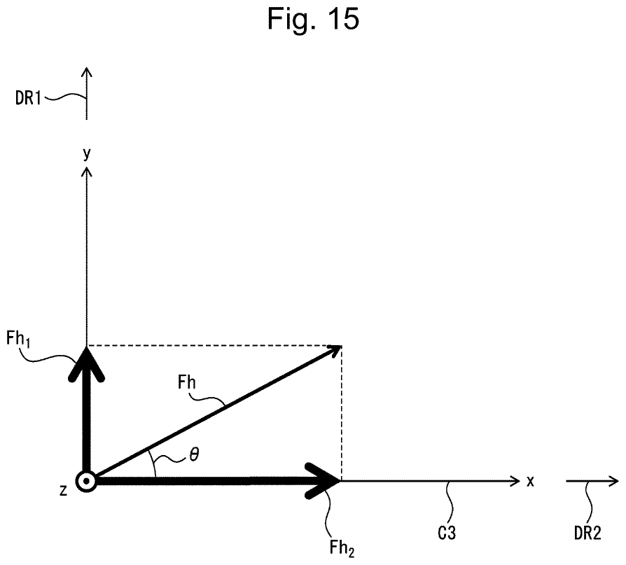

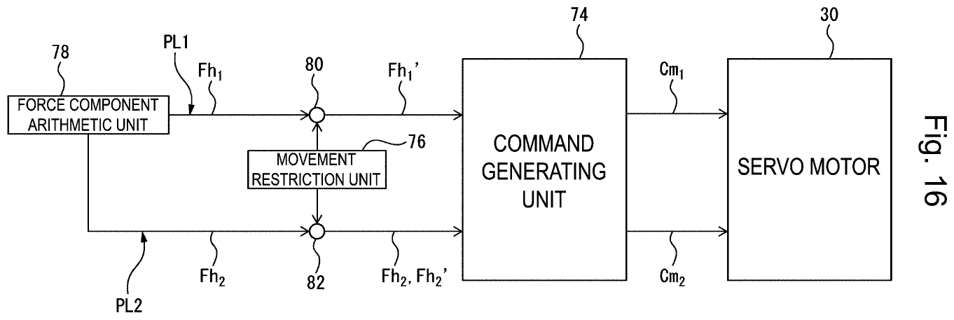

In FIG. 15, the movement vector by the movement command Cm is represented in the operation range coordinate system C3 set in the most recent step S12. The component Cm₁ of the movement command Cm is calculated from the equation Cm₁=Cm·sinθ. Here, θ is an angle between the movement command Cm (movement vector) and the x-z plane (i.e., second direction DR2) of the operation range coordinate system C3. The processor 34 converts the component Cm₁ represented by the operation range coordinate system C3 into the robot coordinate system C1 to be generated as the first movement command Cm₁.

The first movement command Cm₁ includes, for example, a first position command Cmₚ₁, a first velocity command Cmᵥ₁, a first torque command Cm_{q1}, or a first acceleration command Cmₐ₁. The first position command Cmₚ₁ is a command to move the end effector 28 in the y-axis plus direction (first direction DR1) of the operation range coordinate system C3 to a position Pt_{y} (FIG. 11) of the y-axis coordinate of the operation range coordinate system C3 at the target position Pt.

The first velocity command Cmᵥ₁ includes a velocity command value V1 specifying a velocity V1 that moves the end effector 28 in the y-axis plus direction of the operation range coordinate system C3 to the position Pt_{y}. The first torque command Cm_{q1} includes a torque command value q1 specifying the torque q1 that drives each servo motor 30 when the end effector 28 is moved to the position Pt_{y}. The first acceleration command Cmₐ₁ includes an acceleration command value a1 that specifies an acceleration a1 when the end effector 28 is moved to the position Pt_{y}.

In addition, the processor 34 calculates the component Cm₂ in the x-z plane (i.e., second direction DR2) of the operation range coordinate system C3 on the basis of the coordinates Qo and the movement command Cm. In the example illustrated in FIG. 11, the component Cm₂ is expressed as Cm₂=Cm·cosθ. The processor 34 converts the component Cm₂ represented in the operation range coordinate system C3 to the robot coordinate system C1 to be generated as the second movement command Cm₂. The second movement command Cm₂ includes a second position command Cmₚ₂, a second velocity command Cmᵥ₂, a second torque command Cm_{q2}, or a second acceleration command Cmₐ₂, or the like.

In the example illustrated in FIG. 11, a second position command Cmₚ₂ is a command to move the end effector 28 in the x-axis plus direction (second direction DR2) of the operation range coordinate system C3 to a position Ptₓ of the x-axis coordinates in the operation range coordinate system C3 at the target position Pt. A second velocity command Cmᵥ₂ includes a velocity command value V2 specifying the velocity V2 that moves the end effector 28 to the position Ptₓ in the x-axis plus direction of the operation range coordinate system C3.

A second torque command Cm_{q2} includes a torque command value q2 specifying a torque q2 that drives each servo motor 30 when the end effector 28 is moved to the position Ptₓ. A second acceleration command Cmₐ₂ includes an acceleration command value a2 specifying an acceleration a2 when the end effector 28 is moved to the position Ptₓ. Thus, the processor 34 functions as the command generating unit 74 and generates the first movement command Cm₁ and the second movement command Cm₂ based on the operation range coordinate system C3.

In step S17, the processor 34 determines whether or not the target position Pt obtained in the most recent step S13 is outside the allowable operation range 100. When the target position Pt is outside the allowable operation range 100, the processor 34 determines YES and proceeds to step S19, on the other hand, when determining NO, proceeds to step S18.

In step S18, the processor 34 restricts the movement of the robot 12. Specifically, the processor 34 decreases the command value (e.g., velocity command value V1, torque command value q1, acceleration command value a1) of the first movement command Cm₁ generated in the most recent step S16, thereby restricting the movement of the robot 12 (specifically, end effector 28) by the first movement command Cm₁.

As an example, the processor 34 may reduce the velocity command value V1, the torque command value q1, or the acceleration command value a1 included in the first movement command Cm₁ by multiplying (i.e., β·V1, β·q1, or β·a1) the command value V1, q1, or a1 by a predetermined coefficient β (e.g., β<1). The coefficient β may be defined as a function: β=f(δ) of the distance o from the boundary 100a to the current position Pc.

This function: β=f(δ) may be defined such that the coefficient β becomes smaller as the distance δ becomes smaller (i.e., as the current position Pc approaches the boundary 100 a), and β=0 when δ=0 (when the current position Pc is on the boundary 100a). That is, in this case, when the end effector 28 reaches the boundary 100a, the command value V1, q1 or a1 of the first movement command Cm₁ that moves the end effector 28 in the first direction DR1 becomes 0, and as a result, the movement of the end effector 28 in the first direction DR1 is prohibited.

As another example, the processor 34 may restrict the movement of the end effector 28 in the first direction DR1 by correcting the first position command Cmₚ₁ included in the first movement command Cm₁. For example, the processor 34 may correct the first position command Cmₚ₁ such that the target position Pt_{y} in the first direction DR1 of the end effector 28 by the first position command Cmₚ₁ becomes inside the boundary 100a.

Thus, by adding arithmetic processing such as multiplication by coefficient β or correction of the position command Cmₚ₁, the processor 34 changes the first movement command Cm₁ generated in step S15 to the first movement command Cm₁′, which is supplied to each servo motor 30. Thus, the movement of the robot 12 by the first movement command Cm₁ can be restricted.

On the other hand, the processor 34 permits the movement of the robot 12 by the second movement command Cm₂. As an example, the processor 34 supplies the second movement command Cm₂ generated in step S15 to each servo motor 30 without making any changes. Namely, in this case, the processor 34 supplies the second position command Cmₚ₂, the second velocity command Cmᵥ₂ (velocity command value V2), the second torque command Cm_{q2} (torque command value q2), or the second acceleration command Cmₐ₂ (acceleration command value a2) included in the second movement command Cm₂ to each servo motor 30 without making any changes.

Thus, in this case, the command value V2, q2, or a2 of the second movement command Cm₂ does not decrease, and the processor 34 moves the end effector 28 in the second direction DR2 (in the example in FIG. 11, the x-axis plus direction in the operation range coordinate system C3) in response to the second movement command Cm₂ (command value V2, q2 or a2).

As another example, the processor 34 may set the velocity command value V2, the torque command value q2, or the acceleration command value a2 included in the second movement command Cm₂ to a constant Vc (≥V2), qc (≥q2), or ac (≥a2) not less than the value acquired in step S16 to obtain the second movement command Cm₂′, which is supplied to each servo motor 30. That is, in this case, the processor 34 moves the end effector 28 in the second direction DR2 with the fixed velocity Vc, the torque qc, or the acceleration ac.

As another example, the processor 34 may multiply the velocity command value V2, the torque command value q2, or the acceleration command value a2 included in the second movement command Cm₂ by a predetermined coefficient γ (i.e., as γ·V2, γ·q2, or γ·a2) to obtain the second movement command Cm₂′, which is supplied to each servo motor 30. Here, the coefficient γ may be determined as a function: γ=f(δ) of the distance δ.

This function: γ=f(δ) may be determined such that the coefficient γ increases as the distance δ decreases. That is, in this case, the command value γ·V2, γ·q2, or γ·a2 of the second movement command Cm₂ does not decrease with the distance δ, but rather, as the end effector 28 approaches the boundary 100a, the movement of the end effector 28 toward the second direction DR2 is promoted (accelerated).

Thus, the processor 34 permits the movement of the robot 12 by the second movement command Cm₂ (or not restricted). Thus, the processor 34 functions as a movement restriction unit 76 (FIG. 2) that restricts the movement of the robot 12 by the first movement command Cm₁ and permits the movement of the robot 12 by the second movement command Cm₂. After step S18, the processor 34 proceeds to step S6 in FIG. 4.

On the other hand, when YES is determined in step S17, in step S19, the processor 34 functions as the movement restriction unit 76 to restrict the movement of the robot 12. Specifically, the processor 34 prohibits the movement of the robot 12 in the first direction DR1. For example, the processor 34 prohibits the movement of the robot 12 in the first direction DR1 by setting the velocity command value V1, the torque command value q1, or the acceleration command value a1 included in the first movement command Cm₁ to 0. Alternatively, the processor 34 may correct the first position command Cmₚ₁ such that the target position Pt_{y} in the first direction DR1 by the first position command Cmₚ₁ included in the first movement command Cm₁ becomes on (or inside) the boundary 100a.

Thus, the processor 34, by changing the command value V1, q1, or a1 to 0, or by performing arithmetic processing such as correcting the position command Cmₚ₁, changes the first movement command Cm₁ generated in the step S15 to the first movement command Cm₁′, which is supplied to each servo motor 30. Thus, the movement of the end effector 28 in the first direction DR1 can be prohibited. On the other hand, the processor 34 permits the movement of the robot 12 by the second movement command Cm₂ as in step S18 described above (or not restricted).

The movement restriction processing in steps S18 and S19 is schematically illustrated in FIG. 12. As illustrated in FIG. 12, the first movement command Cm₁ generated by the command generating unit 74 in step S15 is sent to a first signal processing line PL1 and is inputted into an arithmetic element 80 by the movement restriction unit 76. Then, in step S18 or S19, the movement restriction unit 76 performs arithmetic processing such as multiplication of the coefficient β for movement restriction on the first movement command Cm₁, which is changed to the first movement command Cm₁′. Then, the first movement command Cm₁′ is outputted to the servo motors 30, and the servo motors 30 move the robot 12 in a restricted manner according to the first movement command Cm₁′. Thus, the above-mentioned restriction is applied to movement of the robot 12 by the first movement command Cm₁.

On the other hand, the second movement command Cm₂ generated by the command generating unit 74 in step S15 is sent to a second signal processing line PL2 different from the first signal processing line PL1 and is inputted into an arithmetic element 82 by the movement restriction unit 76. Then, in step S18 or S19, the movement restriction unit 76 either supplies the second movement command Cm₂ to each servo motor 30 without making any change, or performs arithmetic processing such as multiplication of coefficient γ to obtain the second movement command Cm₂′, which is supplied to each servo motor 30.

Thus, the movement of the robot 12 by the second movement command Cm₂ is permitted. Thus, in the present embodiment, the first movement command Cm₁ and the second movement command Cm₂ generated by the command generating unit 74 are sent to the different signal processing lines PL1 and PL2, and different signal processing is performed for each command by the movement restriction unit 76.

In step S20, the processor 34 generates an alarm AL. For example, the processor 34 generates an image or a voice alarm AL that is “The robot is not allowed to move to the outside of the allowable operation range”. Then, the processor 34 displays the generated alarm AL on the display device 40 (or 50) or outputs it through a speaker (not illustrated).

Alternatively, the controller 14, the teaching device 16, or the robot 12 may be provided with a light emitting device (rotary lamp, LED lamp, or the like), and the processor 34 may generate an alarm AL that causes the light emitting device to emit light. Alternatively, the teaching device 16 or the robot 12 may be provided with a vibrator (or tactile generating device), and the processor 34 may generate an alarm AL that vibrates the vibrator. After step S20, the processor 34 proceeds to step S6 in FIG. 4.

Referring again to FIG. 4, in step S6, the processor 34 determines whether or not an operation end command has been received from the operator, the host controller, or the computer program PG. When YES is determined, the processor 34 ends the flow of FIG. 4, and when NO is determined, the process returns to step S1.

As described above, in the present embodiment, the processor 34 functions as the force acquisition unit 62, the position acquisition unit 64, the reference point setting unit 66, the direction setting unit 68, the position arithmetic unit 70, the notification signal generating unit 72, the command generating unit 74, and the movement restriction unit 76 to restrict the movement of the robot 12 toward the outside of the allowable operation range 100. Thus, the force acquisition unit 62, the position acquisition unit 64, the reference point setting unit 66, the direction setting unit 68, the position arithmetic unit 70, the notification signal generating unit 72, the command generating unit 74, and the movement restriction unit 76 constitute an apparatus 60 (FIG. 2) that restricts the movement of the robot 12 toward the outside of the allowable operation range 100.

In the present apparatus 60, the position acquisition unit 64 acquires the current position Pc of the robot 12 (step S2), and the direction setting unit 68 determines, on the basis of the current position Pc acquired by the position acquisition unit 64 and the boundary 100a of the allowable operation range 100 close to the current position Pc, the first direction DR toward the outside of the allowable operation range 100 and the second direction DR2 orthogonal to the first direction DR1 (step S12).

In order to move the robot 12, the command generating unit 74 generates the first movement command Cm₁ for moving the robot 12 in the first direction DR1 determined by the direction setting unit 68 and the second movement command Cm₂ for moving the robot 12 in the second direction DR2 determined by the direction setting unit 68. The movement restriction unit 76 restricts the movement of the robot 12 by the first movement command Cm₁, and permits the movement of the robot 12 by the second movement command Cm2 (step S18, S19).

According to this configuration, the robot 12 can surely avoid moving to the outside of the allowable operation range 100, thereby ensuring the safety of the operation of the robot 12. On the other hand, for example, there is a case in which the operator wants to move the robot 12 (end effector 28) along the boundary 100a of the allowable operation range 100 (i.e., in the second direction DR2) while performing the above teaching. In such a case, the operator can effectively move the robot 12.

In addition, in the apparatus 60, the reference point setting unit 66 sets the point Pr on the boundary 100a close to the current position Pc acquired by the position acquisition unit 64 as the reference point Pr (step S11). Then, the direction setting unit 68 sets the first direction DR1 and the second direction DR2 based on the reference point Pr set by the reference point setting unit 66 (step S12). According to this configuration, the first direction DR1 and the second direction DR2 can be properly set on the boundary 100a in response to the current position Pc of the robot 12. As a result, the movement of the robot 12 in the first direction DR1 by the first movement command Cm₁ can be properly restricted.

In the apparatus 60, the reference point setting unit 66 sets the point Pr, as the reference point Pr, on the boundary 100a in which the distance δ from the current position Pc is the minimum. According to this configuration, the reference point Pr as the reference point of the first direction DR1 and the second direction DR2 can be appropriately determined corresponding to the current position Pc. In addition, in the apparatus 60, the direction setting unit 68 determines, as the first direction DR1, the normal direction of the boundary 100a at the reference point Pr determined by the reference point setting unit 66. According to this configuration, for example, even when the boundary 100a is curved (e.g., circular), the first direction DR1 can be appropriately determined corresponding to the current position Pc of the robot 12.

In the apparatus 60, the direction setting unit 68 sets the operation range coordinate system C3, which has the reference point Pr determined by the reference point setting unit 66 as the origin, the first axis (y-axis) defining the first direction DR1, and the second axis (x-axis, z-axis) defining the second direction DR1. Then, the command generating unit 74 generates the first movement command Cm₁ in the direction of the first axis (y-axis direction) and the second movement command Cm₂ in the direction of the second axis (x-z plane direction) based on the operation range coordinate system C3. According to this configuration, the arithmetic processing of the first movement command Cm₁ and the second movement command Cm₂ can be executed in parallel independently of each other based on the operation range coordinate system C3, and the efficiency of the arithmetic processing can be increased.

In the apparatus 60, the command generating unit 74 generates the movement command Cm that moves the robot 12 to the outside of the allowable operation range 100 (step S15), generates the component Cm₁ in the first direction DR1 of the movement command Cm as the first movement command Cm₁, and generates the component Cm₂ in the second direction DR1 of the movement command Cm as the second movement command Cm₂. According to this configuration, the first movement command Cm₁ and the second movement command Cm₂ can be generated from the movement command Cm by a relatively simple algorithm. Thus, the arithmetic processing for generating the first movement command Cm₁ and the second movement command Cm₂ can be accelerated.

In the apparatus 60, the first movement command Cm₁ and the second movement command Cm₂ include command values V1 and V2, a1 and a2, or q1 and q2, which define the velocity V1 and V2 of the robot 12, the acceleration a1 and a2 of the robot, or the torque q1 and q2 for driving the robot 12, respectively. The movement restriction unit 76 reduces the command values V1, a1 or q1 of the first movement command Cm₁, thereby restricting the movement of the robot 12 by the first movement command Cm₁.

On the other hand, the movement restriction unit 76 permits the movement of the robot 12 by the second movement command Cm₂ without reducing the command values V2, a2 or q2 of the second movement command Cm₂. According to this configuration, the movement restriction of the robot 12 by the first movement command Cm₁ can be achieved by a simple algorithm, and more various movement restrictions can be designed, for example, by appropriately setting the coefficient ϵ described above. The movement restriction unit 76 may slightly decrease the command values V2, a2 or q2 of the second movement command Cm₂ to the extent that the movement of the robot 12 by the second movement command Cm₂ is permitted.

In the apparatus 60, the position arithmetic unit 70 obtains the target position Pt to which the robot 12 is moved from the current position Pc, and the notification signal generating unit 72 generates the notification signal Sn which notifies the movement direction DRm from the current position Pc to the target position Pt or the distance o between the target position Pt and the boundary 100a (step S14). According to this configuration, the operator can intuitively recognize the movement direction DRm or the distance δ.

In addition, in the apparatus 60, when the target position Pt obtained by the position arithmetic unit 70 is outside the allowable operation range 100 (YES in step S17), the movement restriction unit 76 prohibits the movement of the robot 12 in the first direction DR1 (step S19). According to this configuration, the robot 12 can be reliably prevented from moving to the outside of the allowable operation range 100.

The flows illustrated in FIGS. 4 and 6 are examples, and various changes can be made to these flows. For example, after starting the flow illustrated in FIG. 6, the processor 34 may first execute steps S13 and S15, then execute steps S11, S12, and S14, and then sequentially execute steps S16 to S20.

In the present embodiment, it has been described that in step S11, the processor 34 determines, as a point P on the boundary 100a close to a current position Pc, a point Pr on the boundary 100a at which the distance o from the current position Pc becomes the minimum (δ=δ0) as the reference point Pr. However, the point P on the boundary 100a close to the current position Pc may be determined by any other algorithm.

For example, in step S11, the processor 34 may determine an intersection P between the direction of one axis (e.g., the z-axis of the tool coordinate system C2 in FIG. 9) of the tool coordinate system C2 and the boundary 100a at this time, as the reference point Pr. Alternatively, in the flow of FIG. 6, when steps S13 and S15 are executed first and then step S11 is executed, the processor 34 may obtain a movement direction Dm (FIG. 9) in step S13 or S15, and then determine, as the reference point Pr, the intersection P between the obtained movement direction Dm and the boundary 100a at subsequent step S11.

In the present embodiment, the case in which the processor 34 determines the normal direction of the boundary 100a at the reference point Pr as the first direction DR1 (y-axis direction of the operation range coordinate system C3) in step S12 described above, has been described. However, not limited to this, the processor 34 may determine the first direction DR1 (y-axis direction of the operation range coordinate system C3) by any other algorithm. For example, in step S12, the processor 34 may determine the direction from the origin (FIG. 8) of the tool coordinate system C2 at this time point to the point Pr on the boundary 100a in which the distance o from the origin is the minimum as the first direction DR1 (y-axis plus direction of the operation range coordinate system C3).

In the present embodiment, a case has been described in which the processor 34 determines the operation range coordinate system C3 in step S12 described above. However, not limited to this, in step S12, the processor 34 may determine the first direction DR1 and the second direction DR2 based on the reference point Pr without setting the operation range coordinate system C3.

Note that step S14 may be omitted from the flow of FIG. 6. That is, in this case, notification signal generating unit 72 can be omitted from the apparatus 60. In addition, step S20 may be omitted from the flow of FIG. 6. In the above embodiments, the case in which the processor 34 can execute the jog mode MD1 and the direct teaching mode MD2, has been described. However, not limited to this, the processor 34 may execute only the jog mode MD1 without executing the direct teaching mode MD2. That is, in this case, the force sensor 32 can be omitted from the robot 12 and the force acquisition unit 62 can be omitted from the apparatus 60.

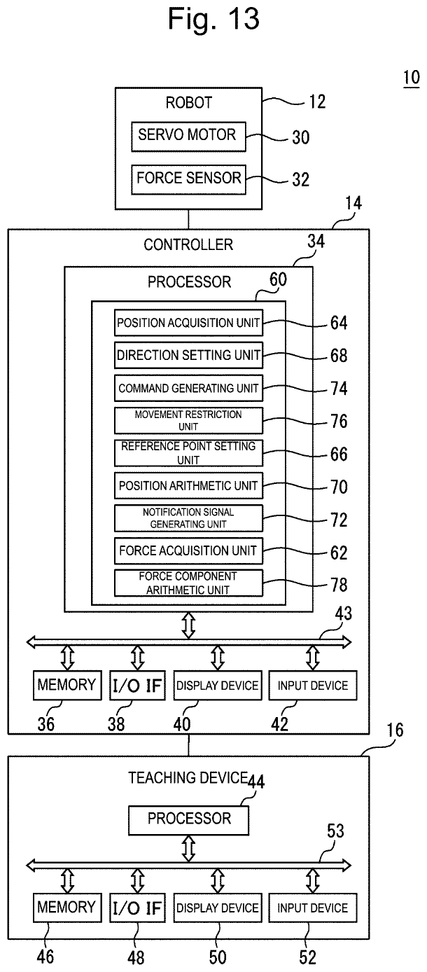

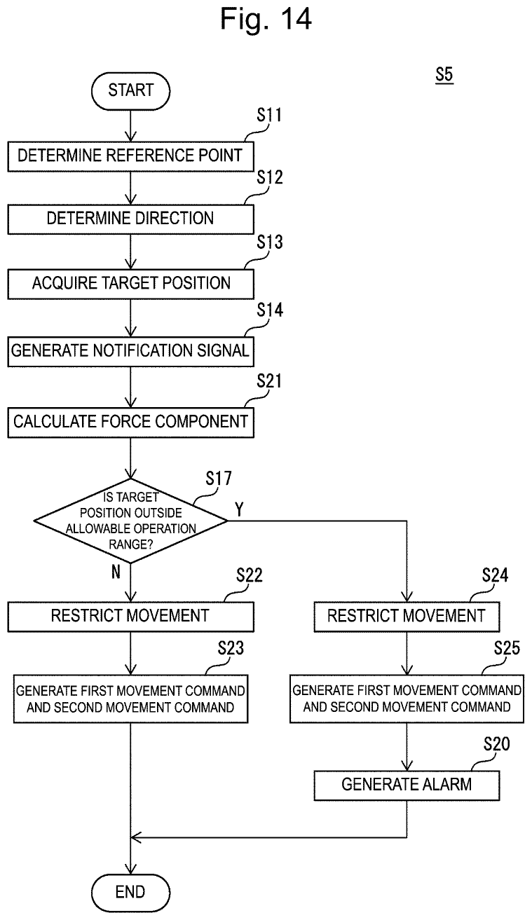

Next, other functions of the robot system 10 will be described with reference to FIG. 13. In the present embodiment, the processor 34 functions as the apparatus 60, but the apparatus 60 further includes the function of a force component arithmetic unit 78. The functions of the robot system 10 illustrated in FIG. 13 will be described below with reference to FIG. 4 and FIG. 14. In the present embodiment, the processor 34 executes the flow of FIG. 4 under the above-described direct teaching mode MD2.

Thus, in step S1, the processor 34 determines whether or not a command to move the robot 12 (handling force Fh) has been received on the basis of the handling force Fh obtained by functioning as the force acquisition unit 62. Here, in the present embodiment, the processor 34 executes the flow of FIG. 14 as step S5 (movement restriction process). In the flow illustrated in FIG. 14, the processes similar to those in the flow of FIG. 6 are given the same step numbers, and duplicate descriptions are omitted.

In step S5 of FIG. 14, after executing the steps S11 to S14 described above, in step S21, the processor 34 obtains the first force component Fh₁ in the first direction DR1 and the second force component Fh₂ in the second direction DR2, of the handling force Fh obtained in the most recent step S1. The calculation of this force component will be described with reference to FIG. 15.

In FIG. 15, the vector (i.e., magnitude and direction) of the handling force Fh obtained in the most recent step S1 is represented in the operation range coordinate system C3 set in the most recent step S12. In FIG. 15, the component Fh₁ of the handling force Fh in the y-axis direction (i.e., first direction DR1) of the operation range coordinate system C3 is represented by Fh₁=Fh·sinθ. On the basis of the coordinates Qo of the operation range coordinate system C3 in the robot coordinate system C1 and the handling force Fh obtained in the most recent step S1, the processor 34 computes the component Fh₁ represented in the operation range coordinate system C3, which is then converted to the robot coordinate system C1, and obtained as the first force component Fh₁.

On the other hand, the component Fh₂ of the handling force Fh in the x-z plane (i.e., second direction DR2) of the operation range coordinate system C3 is represented as Fh₂=Fh·cosθ. On the basis of the coordinates Qo and the handling force Fh, the processor 34 computes the component Fh₂ represented in the operation range coordinate system C3, which is converted to the robot coordinate system C1, and obtained as the second force component Fh₂. Thus, the processor 34 functions as the force component arithmetic unit 78 (FIG. 13), which obtains the component Fh₁ in the first direction DR1 of the handling force Fh as the first force component Fh₁, and obtains the component Fh₂ in the second direction DR2 of the handling force Fh as the second force component Fh₂.

After step S21, the processor 34 executes step S17. When NO is determined in step S17, in step S22, the processor 34 functions as the movement restriction unit 76 to restrict the movement of the robot 12. Specifically, the processor 34 decreases the first force component Fh₁ obtained in the most recent step S21, thereby restricting the movement of the robot 12 by the first movement command Cm₁ generated in the subsequent step S23.

As an example, the processor 34 may reduce the first force component Fh₁ by multiplying the first force component Fh₁ by a predetermined coefficient ϵ (e.g., ϵ<1) (i.e., ϵ·Fh₁), which is changed to the first force component Fh₁′. The coefficient ϵ may be determined as a function: ϵ=f(δ) of the distance δ from the current position Pc to the boundary 100a.

This function: ϵ=f(δ) may be determined such that the coefficient ϵ decreases as the distance δ decreases, and ϵ=0 when δ=0. That is, in this case, when the end effector 28 reaches the boundary 100a, the first movement command Cm₁ generated in the subsequent step S23 becomes 0, and as a result, the movement of the end effector 28 in the first direction DR1 is prohibited.

On the other hand, the processor 34 permits the movement of the robot 12 by the second movement command Cm₂ generated in the subsequent step S23 without decreasing the second force component Fh₂ (or not restricted). As an example, the processor 34 does not change the second force component Fh₂. As another example, the processor 34 may change the second force component Fh₂ to the second force component Fh₂′ by setting the second force component Fh₂ to a constant Fhc (≥Fh2) no less than the value obtained in step S21.

As another example, the processor 34 may change the second force component Fh₂ to the second force component Fh₂′ (=ζ·Fh2) by multiplying the second force component Fh₂ by a predetermined coefficient ζ. Here, the coefficient ζ may be determined as a function: ζ=f(δ) of the distance δ. This function: ζ=f(δ) may be determined such that the coefficient ζ increases as the distance δ decreases.

That is, in this case, the second force component Fh₂ does not decrease with the distance δ, but rather, as the end effector 28 approaches the boundary 100a, the movement of the end effector 28 in the second direction DR2 is promoted by the second movement command Cm₂ generated in subsequent step S23. Thus, the processor 34 permits the movement of the robot 12 by the second movement command Cm₂ (or not restricted).

In step S23, the processor 34 functions as the command generating unit 74 to generate the first movement command Cm₁ and the second movement command Cm₂. Specifically, the processor 34 generates the first movement command Cm₁ in response to the first force component Fh₁′ (=ϵ·Fh₁) obtained as a result of the preceding step S22, which is then supplied to each servo motor 30. In the preceding step S22, the first force component Fh₁ obtained in step S21 is reduced to the first force component Fh₁′, so that the movement of the end effector 28 in the first direction DR1 by the first movement command Cm₁ generated at this time is restricted.

In addition, the processor 34 generates the second movement command Cm₂ in response to the second force component Fh₂, Fhc, or ζ·Fh₂ obtained as a result of the preceding step S22. In the preceding step S22, the second force component Fh₂ obtained in step S21 is not reduced, the movement of the end effector 28 in the second direction DR2 by the second movement command Cm₂ generated at this time is permitted (or not restricted).

On the other hand, when YES is determined in step S17, in step S24, the processor 34 functions as the movement restriction unit 76 to restrict the movement of the robot 12. Specifically, by setting the first force component Fh₁ obtained in the preceding step S21 to 0, the processor 34 prohibits the movement of the robot 12 in the first direction DR1 by the first movement command Cm₁ generated in the subsequent step S25. Thus, the processor 34 changes the first force component Fh₁ obtained in step S21 to the first force component Fh₁′ (=0). On the other hand, the processor 34 permits the movement of the robot 12 by the second movement command Cm₂ as in step S22 described above (or not restricted).

In step S25, the processor 34 functions as the command generating unit 74 and generates the first movement command Cm₁ and the second movement command Cm₂. Specifically, the processor 34 generates the first movement command Cm₁ in response to the first force component Fh₁′ (=0) obtained as a result of the previous step S24, which is then supplied to each servo motor 30. Thus, the movement of the end effector 28 in the first direction DR1 is prohibited.

In addition, the processor 34 generates the second movement command Cm₂ in response to the second force component Fh₂, Fhc, or ζ·Fh₂ obtained as a result of the previous step S24. Thus, the movement of the end effector 28 in the second direction DR2 is permitted (or not restricted). After step S25, the processor 34 proceeds to step S20 described above.

The movement restriction processing in steps S21 to S25 is schematically illustrated in FIG. 16. As illustrated in FIG. 16, the first force component Fh₁ obtained by the force component arithmetic unit 78 in step S21 is sent to the first signal processing line PL1 and is inputted into the arithmetic element 80 by the movement restriction unit 76. Then, in steps S22 and S24, the movement restriction unit 76 performs arithmetic processing such as multiplication of coefficient ϵ to restrict movement of the first force component Fh₁, which is changed to the first force component Fh₁′.

Then, the first force component Fh₁′ is inputted into the command generating unit 74, and in step S23 or S25, the command generating unit 74 generates the first movement command Cm₁ in response to the first force component Fh₁′, which is outputted to each servo motor 30. The movement of the robot 12 by the thus generated first movement command Cm₁ is restricted as described above.

On the other hand, the second force component Fh₂ obtained by the force component arithmetic unit 78 in step S21 is sent to the second signal processing line PL2 and is inputted into the arithmetic element 82 by the movement restriction unit 76. Then, in step S22 or S24, the movement restriction unit 76 either supplies the second force component Fh₂ to the command generating unit 74 without making any change, or performs arithmetic processing such as multiplication by coefficient ζ and supplies the result to the command generating unit 74 as the second force component Fh₂′.

The command generating unit 74 generates in step S23 or S25, the second movement command Cm₂ in response to the second force component Fh₂ or Fh₂′, which is then supplied to each servo motor 30. The second movement command Cm₂ thus generated permits the movement of the robot 12 in the second direction DR2. As described above, in the present embodiment, the first force component Fh₁ and the second force component Fh₂ generated by the force component generating unit 78 are sent to different signal processing lines PL1 and PL2, and the movement restriction unit 76 performs different signal As described above, in the apparatus 60 illustrated in FIG. 13, the force acquisition unit 62 acquires the handling force Fh added to the robot 12 to move the robot 12 on the basis of the detection data Df of the force sensor 32 that detects the force F added to the robot 12 (step S1). In addition, the force component arithmetic unit 78 obtains the component Fh₁ in the first direction DR1 of the handling force Fh acquired by the force acquisition unit 62 as the first force component Fh₁, and obtains the component Fh₂ in the second direction DR2 of the handling force Fh as the second force component Fh₂ (step S21).

Then, the command generating unit 74 generates the first movement command Cm₁ in response to the first force component Fh₁ obtained by the force component arithmetic unit 78, and generates the second movement command Cm₂ in response to the second force component Fh₂ obtained by the force component arithmetic unit 78 (steps S23, S25). According to this configuration, for example, when the operator adds the handling force Fh to the robot 12 in the direct teaching mode MD2, the robot 12 can be accurately moved in each of the first direction DR1 and the second direction DR2 by the movement amount corresponding to the handling force Fh.

In the apparatus 60 illustrated in FIG. 13, the movement restriction unit 76 restricts the movement of the robot 12 by the first movement command Cm₁ by decreasing the first force component Fh₁, and permits the movement of the robot 12 by the second movement command Cm₂ without decreasing the second force component Fh₂ (steps S22, S24). According to this configuration, the movement restriction of the robot 12 by the first movement command Cm₁ can be achieved by a simple algorithm, and more various movement restrictions can be designed by, for example, appropriately setting the coefficient ϵ described above. The movement restriction unit 76 may slightly decrease the second force component Fh₂ to the extent that the movement of the robot 12 by the second movement command Cm₂ is permitted.

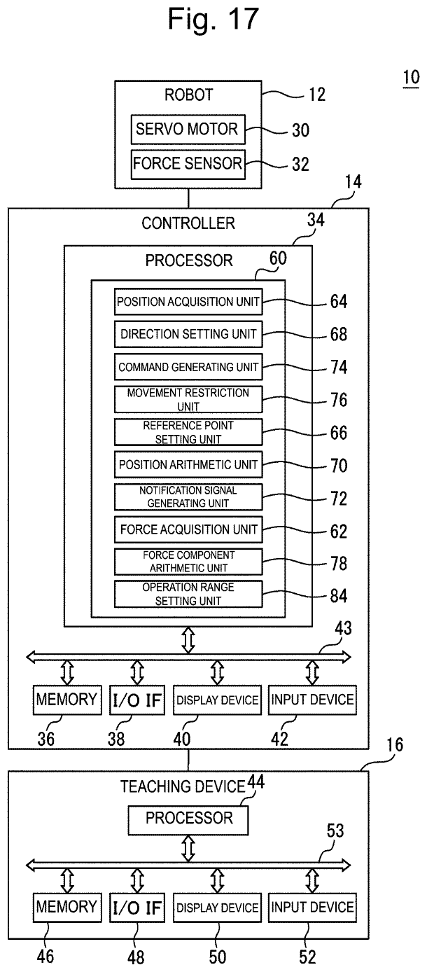

Next, yet other functions of the robot system 10 will be described with reference to FIG. 17. In the present embodiment, the processor 34 functions as the apparatus 60, and the apparatus 60 further has the function of an operation range setting unit 84. The functions of the robot system 10 illustrated in FIG. 13 will be described below. In the present embodiment, the processor 34 executes the flow illustrated in FIG. 6 or FIG. 14, and functions as the movement restriction unit 76 in the above-described steps S18, S19, S22, or S24 to move the robot 12 in a restricted manner (i.e., restrict movement in the first direction DR1, but allow movement in the second direction DR2).

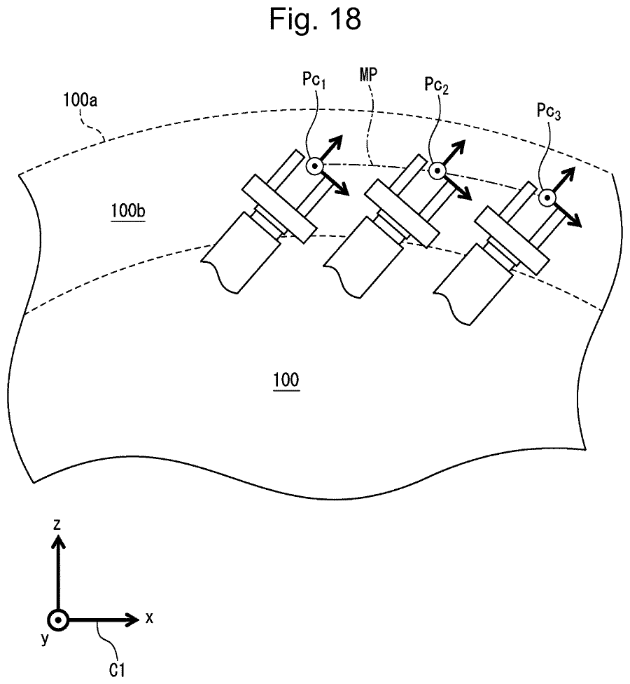

While executing this restricted movement, the processor 34 repeatedly executes the above-described step S2, and functions as the position acquisition unit 64 to repeatedly acquire the current positions Pcₙ (n=1, 2, 3, - - - ) of the robot 12 (i.e. end effector 28). FIG. 18 illustrates the current positions Pc₁, Pc₂, and Pc₃ of the end effector 28 acquired during the restricted movement. In the present embodiment, the processor 34 sets a new allowable operation range 120 on the basis of the current positions Pon acquired during the restricted movement. As an example, the processor 34 sets a new allowable operation range 120 in the robot coordinate system C1 so as to pass through the current positions Pc₁, Pc₂ and Pc₃.

As another example, the processor 34 generates a movement path MP passing through the current positions Pc₁, Pc₂ and Pc₃ on the basis of the current positions Pc₁, Pc₂ and Pc₃, and sets a new allowable operation range 120 in the robot coordinate system C1 so as to contact the generated movement path MP. Thus, in the present embodiment, the processor 34 functions as the operation range setting unit 84 (FIG. 17) that sets a new allowable operation range 120 on the basis of the current positions Pcₙ acquired during the restricted movement.

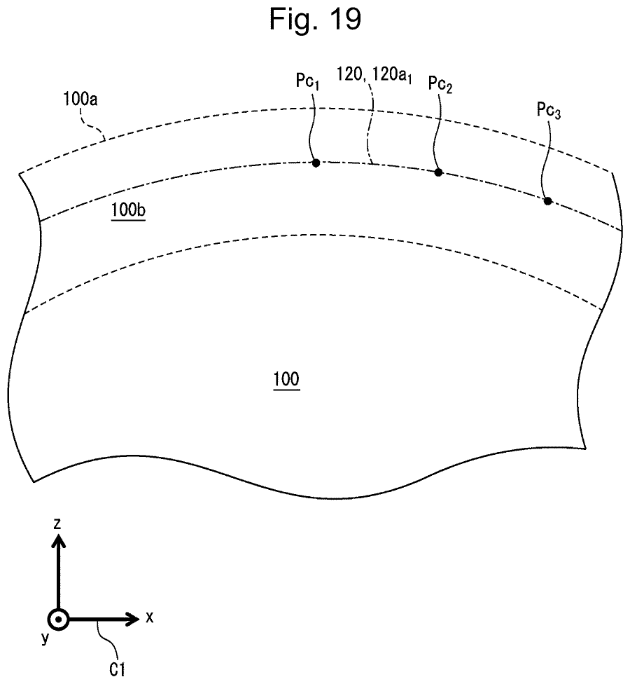

An example of the allowable operation range 120 set in this way is illustrated in FIG. 19. As illustrated in FIG. 19, the allowable operation range 120 is disposed inside the boundary 100a of the predetermined allowable operation range 100, and a boundary 120a of the allowable operation range 120 extends along the boundary 100a (e.g., in parallel). The processor 34 stores the data (e.g., coordinates of the robot coordinate system C1) of the newly set allowable operation range 120 in the memory 36 (or 46). Thereafter, the processor 34 may execute the flow illustrated in FIG. 4 on the basis of the new allowable operation range 120.

As described above, in the apparatus 60 illustrated in FIG. 17, when the movement restriction unit 76 moves the robot 12 in a restricted manner, the position acquisition unit 64 repeatedly acquires the current positions PCₙ of the robot 12. Then, the operation range setting unit 84 sets a new allowable operation range 120 on the basis of the current positions PCₙ acquired by the position acquisition unit 64 during the restricted movement.

According to this configuration, for example, when the operator is teaching by the above-described jog mode MD1 or the direct teaching mode MD2, a new allowable operation range 120 can be easily set from the positions Pcₙ (or movement path MP) of the robot 12 whose movement has been restricted along the boundary 100a of the predetermined allowable operation range 100. Thus, various allowable operation ranges can be arbitrarily set.

In the above-described embodiments, the case in which the predetermined allowable operation range 100 is circular (or cylindrical), has been described. However, the allowable operation range 100 may be any shape, such as a polygon (square, pentagon, or the like) shape, a hemisphere shape, or a random shape consisting of a plurality of curved surfaces.

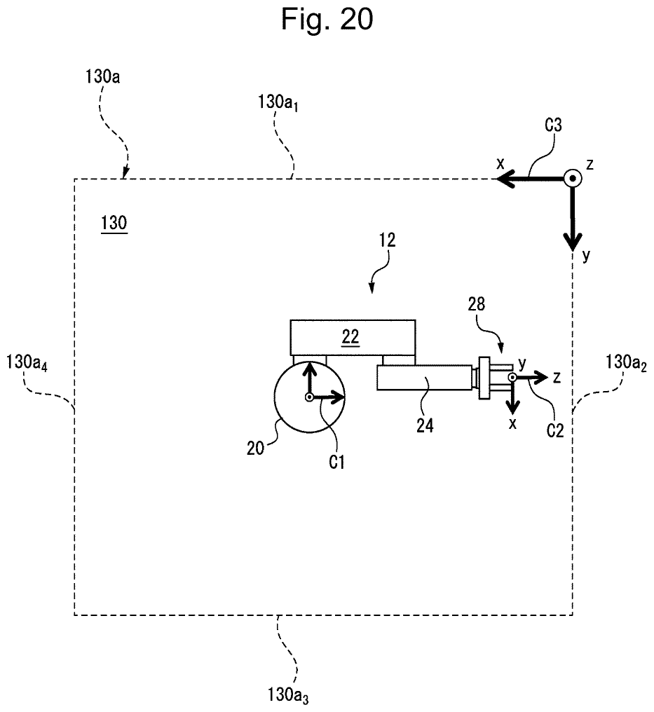

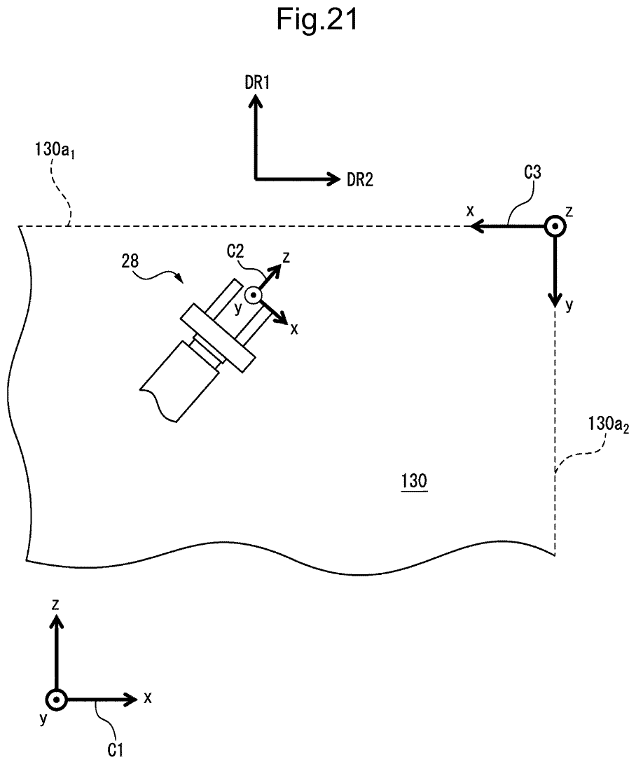

In the above embodiments, the case in which the processor 34 determines the reference point Pr in step S11, has been described. However, not limited to this case, the processor 34 may determine the first direction DR1 and the second direction DR2 without determining the reference point Pr. This embodiment will be described with reference to FIGS. 20 and 21.

In the present embodiment, an approximately rectangular allowable operation range 130 is predetermined, and a boundary 130a of the allowable operation range 130 has boundaries 130a₁, 130a₂, 130a₃, and 130a₄ each defining one side of the rectangle. The operation range coordinate system C3 is predetermined for the allowable operation range 130. The operation range coordinate system C3 is a coordinate system that defines the position of the allowable operation range 130 in the robot coordinate system C1.

In the example illustrated in FIG. 20, the operation range coordinate system C3 is set such that its origin is disposed on the intersection of boundaries 130a₁ and 130a₂ (i.e., one vertex of a rectangle), its x-axis is parallel to the boundaries 130a₁ and 130a₃, its y-axis is parallel to the boundaries 130a₂ and 130a₄, and its z-axis is parallel to the z-axis of the robot coordinate system C1. The coordinates Qo of the operation range coordinate system C3 in the robot coordinate system C1 is known.

In the present embodiment, the processor 34 executes the flow illustrated in FIG. 4 on the basis of the allowable operation range 130. Here, the processor 34, when starting the flow of step S5 in FIG. 6 or FIG. 14, executes step S12 without executing step S11. In step S12, the processor 34 functions as the direction setting unit 68, and determines the first direction DR1 toward the outside of the allowable operation range 130 and the second direction DR2 orthogonal to the first direction DR1 on the basis of the current position Pc obtained in the most recent step S2 and the boundary 130a₁ of the allowable operation range 130 adjacent to the current position Pc.

Specifically, as illustrated in FIG. 21, the processor 34 specifies the boundary 130a₁ adjacent to the current position Pc among the boundaries 130a₁, 130a₂, 130a₃, and 130a₄ of the allowable operation range 130. Next, the processor 34 determines as the first direction DR1, the y-axis minus direction of the operation range coordinate system C3, which is parallel to the normal direction of the specified boundary 130a₁ and faces the outside of the allowable operation range 130. Then, the processor 34 determines the x-z plane direction of the operation range coordinate system C3 orthogonal to the first direction DR1 as the second direction DR2.

Suppose that the current position Pc is adjacent to the boundary 130a₂ among the boundaries 130a₁, 130a₂, 130a₃, and 130a₄ of the allowable operation range 130. In this case, the processor 34 determines the x-axis minus direction of the operation range coordinate system C3 as the first direction DR1, and the y-z plane direction of the operation range coordinate system C3 as the second direction. Thus, in the present embodiment, the first direction DR1 and the second direction can be determined as the x-axis direction or the y-axis direction of the operation range coordinate system C3 depending on the boundary which is close to the current position Pc, among the boundaries 130a₁, 130a₂, 130a₃, or 130a₄.

Thus, the processor 34 determines the first direction DR1 and the second direction DR2 on the basis of the boundary 130a₁ which is close to the current position Pc with the predetermined operation range coordinate system C3 as the reference. In the present embodiment, the processor 34 then sequentially executes steps S13 to S20 in FIG. 6 or steps S13, S14, S21, S17, S22 to 25, and S20 in FIG. 14 with the operation range coordinate system C3 as the reference, on the basis of the first direction DR1 and the second direction DR2. Thus, according to the present embodiment, step S11 can be omitted from the flow of FIG. 4 or FIG. 6. That is, the reference point setting unit 66 can be omitted from the apparatus 60.

The processor 34 may execute the flow illustrated in FIG. 4 according to the computer program PG stored in the memory 36 (or 46) in advance. Moreover, the functions of the apparatus 60 (i.e., force acquisition unit 62, position acquisition unit 64, reference point setting unit 66, direction setting unit 68, position arithmetic unit 70, notification signal generating unit 72, command generating unit 74, movement restriction unit 76, force component arithmetic unit 78, operation range setting unit 84) executed by the processor 34 may be function modules implemented by the computer program PG.

In the above-described embodiment, the processor 34 executes the flow illustrated in FIG. 4 when teaching by the jog mode MD1 or the direct teaching mode MD2. However, not limited to this, for example, the processor 34 may execute the flow illustrated in FIG. 4 when the operator and the robot 12 work together.

In the above-described embodiment, the case in which the functions of the apparatus 60 are implemented in the controller 14, is described. However, not limited to this, at least one of the functions of the apparatus 60 may be implemented at the teaching device 16. For example, the notification signal generating unit 72 among the functions of the apparatus 60 may be implemented at the teaching device 16. In this case, the processor 44 of the teaching device 16 may function as the notification signal generating unit 72 to generate the image 110 illustrated in FIG. 10, which is then displayed at the display device 50. At least one of the functions of the apparatus 60 may be implemented at any computer (such as a PC) other than the controller 14 and the teaching device 16.

The present disclosure has been described in detail above, but is not limited to the above-described individual embodiments. These embodiments may be added, replaced, modified, partially deleted, or the like, to the extent not deviating from the gist of the present disclosure or from the gist of the present disclosure derived from the contents described in the claims and equivalents thereof. These embodiments may also be combined. For example, in the above-described embodiments, the order of each operation and the order of each process are illustrated as examples and are not limited to these orders. The same applies when numerical values or formula are used in the description of the above-described embodiments.

The present disclosure discloses the following aspects.
(Aspect 1) An apparatus 60 configured to restrict a movement of a robot 12 toward an outside of a predetermined allowable operation range 100, 130, the apparatus 60 including: a position acquisition unit 64 configured to acquire a current position Pc of the robot 12; a direction setting unit 68 configured to determine a first direction DR1 toward the outside and a second direction DR2 orthogonal to the first direction DR1, on the basis of the current position Pc acquired by the position acquisition unit 64 and a boundary 100a, 130a of the allowable operation range 100, 130 adjacent to the current position Pc; a command generating unit 74 configured to generate a first movement command Cm₁ for moving the robot 12 in the first direction DR1 determined by the direction setting unit 68, and a second movement command Cm₂ for moving the robot 12 in the second direction DR2 determined by the direction setting unit 68, in order to move the robot 12; and a movement restriction unit 76 configured to restrict a movement of the robot 12 in accordance with the first movement command Cm₁, while permitting a movement of the robot 12 in accordance with the second movement command Cm₂.
(Aspect 2) The apparatus 60 of aspect 1, further including a reference point setting unit 66 configured to determine, as a reference point Pr, a point P on the boundary 100a, 130a adjacent to the current position Pc acquired by the position acquisition unit 64, wherein the direction setting unit 68 is configured to determine the first direction DR1 and the second direction DR2 with reference to the reference point Pr set by the reference point setting unit 66.
(Aspect 3) The apparatus 60 of aspect 2, wherein the reference point setting unit 66 is configured to determine, as the reference point Pr, a point P having a minimum distance o from the current position Pc.
(Aspect 4) The apparatus of aspect 2 or 3, wherein the direction setting unit 68 is configured to determine, as the first direction DR1, a normal direction of the boundary 100a, 130a at the reference point Pr determined by the reference point setting unit 66.
(Aspect 5) The apparatus 60 of any one of aspects 2 to 4, wherein the direction setting unit 68 is configured to set an operation range coordinate system C3, an origin of the operation range coordinate system being the reference point Pr set by the reference point setting unit 66, including a first axis (y-axis) defining the first direction DR1, and a second axis (x-axis, z-axis) defining the second direction DR2, wherein the command generating unit 74 is configured to generate the first movement command Cm₁ in the direction of the first axis, and the second movement command Cm₂ in the direction of the second axis, with reference to the operation range coordinate system C3.
(Aspect 6) The apparatus 60 of any one of aspects 1 to 5, wherein the command generating unit 74 is configured to generate a movement command Cm for moving the robot 12 to the outside, generate a component Cm₁ in the first direction DR1 of the movement command Cm as the first movement command Cm₁, and generate a component Cm₂ in the second direction DR2 of the movement command Cm as the second movement command Cm₂.
(Aspect 7) The apparatus 60 of aspect 6, wherein the first movement command Cm₁ and the second movement command Cm₂ each include a command value V1, V2, a1, a2, q1, q2 that defines a velocity V1, V2 of the robot 12, an acceleration a1, a2 of the robot 12, or a torque q1, q2 to drive the robot 12, wherein the movement restriction unit 76 is configured to restrict the movement of the robot 12 in accordance with the first movement command Cm₁ by decreasing the command values V1, a1, q1 of the first movement command Cm₁, while permitting the movement of the robot 12 in accordance with the second movement command Cm₂ without decreasing the command values V2, a2, q2 of the second movement command Cm₂.
(Aspect 8) The apparatus 60 of any one of aspects 1 to 5, further including: a force acquisition unit 62 configured to acquire a handling force Fh applied to the robot 12 in order to move the robot 12, on the basis of detection data Df of the force sensor 32 that detects a force F applied to the robot 12; and a force component arithmetic unit 78 configured to obtain a component Fh₁ in the first direction DR1 of the handling force Fh acquired by the force acquisition unit 62 as a first force component Fh₁, and obtain a component Fh₂ in the second direction DR2 of the handling force Fh as a second force component Fh₂, wherein the command generating unit 74 is configured to generate the first movement command Cm₁ in response to the first force component Fh₁ obtained by the force component arithmetic unit 78, and generate the second movement command Cm₂ in response to the second force component Fh₂ obtained by the force component arithmetic unit 78.
(Aspect 9) The apparatus 60 of aspect 8, wherein the movement restriction unit 76 is configured to restrict the movement of the robot 12 in accordance with the first movement command Cm₁ by decreasing the first force component Fh₁, while permitting a movement of the robot 12 in accordance with the second movement command Cm₂ without decreasing the second force component Fh₂.
(Aspect 10) The apparatus 60 of any one of aspects 1 to 9, further including: a position arithmetic unit 70 configured to obtain a target position Pt for moving the robot 12 from the current position Pc; and a notification signal generating unit 72 configured to generate a notification signal Sn for notifying a movement direction DRm from the current position Pc to the target position Pt or a distance δ between the target position Pt and the boundary 100a, 130a.
(Aspect 11) The apparatus 60 of any one of aspects 1 to 10, further including a position arithmetic unit 70 configured to obtain a target position Pt for moving the robot 12 from the current position Pc, wherein the movement restriction unit 76 is configured to prohibit the movement of the robot 12 in the first direction DR1, when the target position Pt obtained by the position arithmetic unit 70 is outside the allowable operation range 100, 130.
(Aspect 12) The apparatus 60 of any one of aspects 1 to 11, wherein the position acquisition unit 64 is configured to repeatedly acquire the current positions Pcₙ of the robot 12 when the movement restriction unit 76 move the robot 12 in a restricted manner, wherein the apparatus 60 further comprises an operation range setting unit 84 configured to set a new allowable operation range 120 on the basis of the current position PCₙ acquired by the position acquisition unit 64 during the restricted movement.
(Aspect 13) A method of restricting a movement of a robot 12 toward an outside of a predetermined allowable operation range 100, 130, the method including, by a processor 34, 44: acquiring a current position Pc of the robot 12; determining a first direction DR toward the outside and a second direction DR2 orthogonal to the first direction DR1, on the basis of the acquired current position Pc and a boundary 100a, 130a of the allowable operation range 100, 130 adjacent to the current position Pc; generating a first movement command Cm₁ for moving the robot 12 in the determined first direction DR1, and a second movement command Cm₂ for moving the robot 12 in the determined second direction DR2, in order to move the robot 12, and restricting a movement of the robot 12 in accordance with the first movement command Cm₁, while permitting a movement of the robot 12 in accordance with the second movement command Cm₂.
(Aspect 14) A computer program PG that causes the processor 34, 44 to execute the method of aspect 13.

### REFERENCE SIGNS LIST

10 Robot system
12 Robot
14 Controller
16 Teaching device
32 Force sensor
34, 44 Processor
60 Apparatus
64 Position acquisition unit
66 Reference point setting unit
68 Direction setting unit
70 Position arithmetic unit
72 Notification signal generating unit
74 Command generating unit
76 Movement restriction unit
78 Force component arithmetic unit
84 Operation range setting unit
100, 120, 130 Allowable operation range

1. An apparatus configured to restrict a movement of a robot toward an outside of a predetermined allowable operation range, the apparatus comprising:
a position acquisition unit configured to acquire a current position of the robot;
a direction setting unit configured to determine a first direction toward the outside and a second direction orthogonal to the first direction, on the basis of the current position acquired by the position acquisition unit and a boundary of the allowable operation range adjacent to the current position;
a command generating unit configured to generate a first movement command for moving the robot in the first direction determined by the direction setting unit, and a second movement command for moving the robot in the second direction determined by the direction setting unit, in order to move the robot; and
a movement restriction unit configured to restrict a movement of the robot in accordance with the first movement command, while permitting a movement of the robot in accordance with the second movement command.

2. The apparatus of claim 1, further comprising a reference point setting unit configured to determine, as a reference point, a point on the boundary adjacent to the current position acquired by the position acquisition unit, wherein the direction setting unit is configured to determine the first direction and the second direction with reference to the reference point set by the reference point setting unit.

3. The apparatus of claim 2, wherein the reference point setting unit is configured to determine, as the reference point, the point having a minimum distance from the current position.

4. The apparatus of claim 2, wherein the direction setting unit is configured to determine, as the first direction, a normal direction of the boundary at the reference point determined by the reference point setting unit.

5. The apparatus of claim 2, wherein the direction setting unit is configured to set an operation range coordinate system, an origin of the operation range coordinate system being the reference point set by the reference point setting unit, the operation range coordinate system including a first axis defining the first direction and a second axis defining the second direction, wherein the command generating unit is configured to generate the first movement command in the direction of the first axis and the second movement command in the direction of the second axis, with reference to the operation range coordinate system.

6. The apparatus of claim 1, wherein the command generating unit is configured to:
generate a movement command for moving the robot to the outside;
generate a component in the first direction of the movement command as the first movement command; and
generate a component in the second direction of the movement command as the second movement command.

7. The apparatus of claim 6, wherein the first movement command and the second movement command each include a command value that defines a velocity of the robot, an acceleration of the robot, or a torque to drive the robot, wherein the movement restriction unit is configured to restrict the movement of the robot in accordance with the first movement command by decreasing the command value of the first movement command, while permitting the movement of the robot in accordance with the second movement command without decreasing the command value of the second movement command.

8. The apparatus of claim 1, further comprising:
a force acquisition unit configured to acquire a handling force applied to the robot in order to move the robot; and
a force component arithmetic unit configured to obtain a component in the first direction of the handling force acquired by the force acquisition unit as a first force component, and obtain a component in the second direction of the handling force as a second force component, wherein
the command generating unit is configured to generate the first movement command in response to the first force component obtained by the force component arithmetic unit, and generate the second movement command in response to the second force component obtained by the force component arithmetic unit.

9. The apparatus of claim 8, wherein the movement restriction unit is configured to restrict the movement of the robot in accordance with the first movement command by decreasing the first force component, while permitting the movement of the robot in accordance with the second movement command without decreasing the second force component.

10. The apparatus of claim 1, further comprising:
a position arithmetic unit configured to obtain a target position for moving the robot from the current position; and
a notification signal generating unit configured to generate a notification signal for notifying a movement direction from the current position to the target position or a distance between the target position and the boundary.

11. The apparatus of claim 1, further comprising a position arithmetic unit configured to obtain a target position for moving the robot from the current position, wherein the movement restriction unit is configured to prohibit the movement of the robot in the first direction, when the target position obtained by the position arithmetic unit is outside the allowable operation range.

12. The apparatus of claim 1, wherein the position acquisition unit is configured to repeatedly acquire the current positions when the movement restriction unit moves the robot in a restricted manner, and wherein the apparatus further comprises an operation range setting unit configured to set a new allowable operation range on the basis of the current position acquired by the position acquisition unit during the restricted movement.

13. A method of restricting a movement of a robot toward an outside of a predetermined allowable operation range, the method comprising:
acquiring, by a processor, a current position of the robot;
determining, by the processor, a first direction toward the outside and a second direction orthogonal to the first direction, on the basis of the acquired current position and a boundary of the allowable operation range adjacent to the current position;
generating, by the processor, a first movement command for moving the robot in the determined first direction, and a second movement command for moving the robot in the determined second direction, in order to move the robot; and
restricting, by the processor, a movement of the robot in accordance with the first movement command, while permitting a movement of the robot in accordance with the second movement command.

14. A computer-readable non-transitory recording medium configured to record a computer program that causes the processor to execute the method of claim 13.
